(19) United States
(12) Patent Application Publication
(10) Pub. No.: US 2014/0293030 A1
(43) Pub. Date: Oct. 2, 2014

(54) Real Time Math Using a Camera

(71) Applicant: Texas Instruments Incorporated, Dallas, TX (US)

(72) Inventor: James Joseph Galu, JR., Richardson, TX (US)

(73) Assignee: Texas Instruments Incorporated, Dallas, TX (US)

(21) Appl. No.: 14/213,822

(22) Filed: Mar. 14, 2014

Related U.S. Application Data
(60) Provisional application No. 61/805,284, filed on Mar. 26, 2013.

(51) Int. Cl. G06F 15/02; G06K 9/18; H04N 5/232

(52) U.S. Cl. CPC G06F 15/0225; H04N 5/23293; G06K 9/18
USPC 348/61

(57) ABSTRACT

A mobile device, such as a smartphone, may be provided with a camera. Embodiments of the invention allow the smartphone to display a screen image of a document that includes an expression or an equation on a display screen of the smartphone and then to provide an indication of a real-time solution to the equation that is shown on the display screen. In some embodiments, the screen image may be provided by the camera in the smartphone that is viewing a surface upon which the equation is written. When the expression does not include a solution, then the real time solution may be superimposed on the screen to complete the equation. When the equation does include a solution, then an indication of correctness may be superimposed on the screen image of the equation.

### CLAIM OF PRIORITY UNDER 35 U.S.C. 119(e)

The present application claims priority to and incorporates by reference U.S. Provisional Application No. 61/805,284 (attorney docket TI-71902PS) filed Mar. 26, 2013, entitled “Real Time Math Using Camera On Mobile Devices.”

### BACKGROUND OF THE INVENTION

1. Field of the Invention

Embodiments of the present invention generally relate to solving math problems embedded in images, such as images provided by a camera.

2. Description of the Related Art

With ever increasing frequency, school classrooms are equipped with a classroom learning system in which digital devices, e.g., handheld calculators, for student use are connected via a network to a host computer used by the teacher. Such a classroom learning system allows a teacher to perform actions such as creating and managing lessons, transferring files between the computer and the digital devices, monitoring student activity on the digital devices using screen captures, polling, assessments, etc., and performing various interactive activities with the students. Various tools are also provided for creating, distributing, and analyzing educational content. The TI-Nspire(™) Navigator(™) System from Texas Instruments, Inc. is an example of such a classroom learning system.

In addition to calculator based networks, schools are now embarking on BYOD (Bring Your Own Device) initiatives. In various schools, students are using various computing devices other than calculators that they own, such as: tablets, iPads, laptops, smartphones, etc, for example.

Even with all of the electronic learning tools, math problems may often be presented in books or pamphlets, on paper, white boards, chalk boards, or on various other surfaces, for example. Various documents that contain equations may be accessed from on-line sources via various networks, such as local area networks, wide area networks, the World Wide Web, cellular networks, etc., for example.

### SUMMARY OF THE INVENTION

Embodiments of the invention allow a device such as a smartphone to display a screen image of a document that includes an expression or an equation on a display screen of the device and then to provide an indication of a real-time solution to the equation that is shown on the display screen. In some embodiments, the screen image may be provided by a camera in the mobile device that is viewing a surface upon which the equation is written. When the expression does not include a solution, then the real time solution may be superimposed on the screen to complete the equation. When the equation does include a solution, then an indication of correctness may be superimposed on the screen image of the equation.

### BRIEF DESCRIPTION OF THE DRAWINGS

Particular embodiments in accordance with the invention will now be described, by way of example only, and with reference to the accompanying drawings:

FIGS. 1A-1B are illustrations of expressions and equations;

FIG. 2 is an illustration of a smartphone that is being used to observe an equation written on a surface, such as a piece of paper;

FIGS. 3-6 illustrate aspects of performing real-time evaluation of equations or other text displayed on a screen of the smartphone of FIG. 2;

FIG. 7 is a flow chart illustrating a method for evaluating equations by observing an image of the equations;

FIG. 8 is a block diagram of a digital camera contained within the smartphone of FIGS. 2-6; and

FIG. 9 is a more detailed block diagram of a smartphone with an embedded camera.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Math problems may often be presented in books or pamphlets; on paper, on white boards and chalk boards; or on various other surfaces, for example. Various documents that contain equations may be accessed from on-line sources via various networks, such as local area networks, wide area networks, the World Wide Web, cellular networks, etc., for example. Determining a solution for an equation, or verifying that a provided answer is correct may require sharp thinking, paperwork, or calculators to work out. Often it is desirable that the source of the math problem remain undisturbed, such as for textbooks, whiteboards, notebooks, etc., for example.

Embodiments of the invention may provide faster and more reliable results than hand calculations, even when a calculator is used. Embodiments of the invention allow the source of a math problem to remain undisturbed, as will be described in more detail below.

In one embodiment, a camera on a smartphone may be used to capture an image of an expression or equation in real time. For example, a teacher may write an expression such as 2+2=? on a white board. A student may then capture an image of the expression on the white board using a smartphone camera. Optical character recognition (OCR) software on the smartphone may then interpret the characters of the math problem. A computation software program may then be executed to provide a real time solution to the expression and superimpose a real time answer on the video screen of the smartphone.

This will allow the user to rapidly solve a math problem with their mobile device without disturbing the original source (whiteboard, notebook, etc.). In a similar manner, a parent may wave their smartphone over their child's homework to check it, for example.

Thus, an embodiment of the invention may allow a smartphone to function as an automatic simple math solver and allow the source of the problem to remain undisturbed. It may eliminate manual data entry for the math problem which may serve as a handicap aid. It may remove the need to use a virtual keyboard on the smartphone for many applications. It may allow a smartphone to be used as a math accuracy scanner allowing a parent or a teacher to cover more area in less time, for example.

In another embodiment, expressions and equations within a document, such as a .pdf document or a PowerPoint document, for example, may be analyzed and a real time solution may be provided and/or compared to a solution that was included in the document. In this case, the documents may have been obtained from local file storage within the device, or they may have been obtained from on-line sources via various networks, such as local area networks, wide area networks, the World Wide Web, cellular networks, etc., for example.

Embodiments of the present invention are discussed below with respect to an embodiment on a smartphone that contains various software applications. It should be noted, however, that embodiments of the present invention may be useful for other types of electronic devices, such as: laptop computers, desktop computers, handheld computing devices, head-mounted devices, wrist mounted devices, vehicle mounted devices, wall mounted devices, drone mounted devices, etc., for example. Examples of other types of handheld computing devices in which embodiments of the present invention may be useful include: tablet computers, scientific calculators, advanced calculators able to upload and run software applications, handheld-sized limited-purpose computer devices, handheld-sized educational computer devices, handheld-sized portable computer devices, portable computer devices, personal digital assistants (PDAs), palmtop computers, cellular or mobile telephones, and any combination thereof, for example.

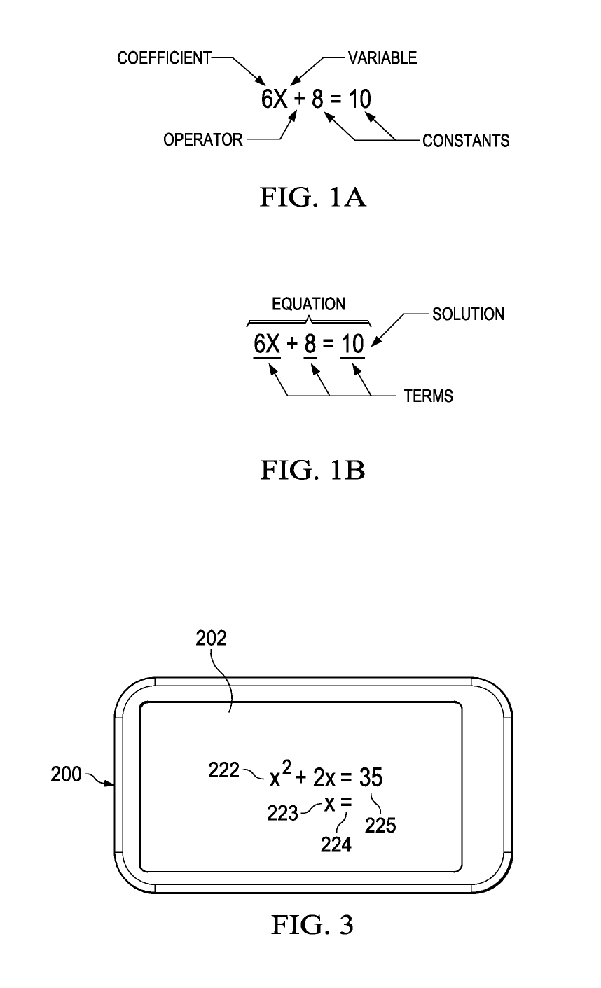

FIGS. 1A-1B illustrate the various parts of an algebraic equation and terminology that will be used in the following description. A variable is a symbol for a number that is not yet known. It is usually a letter such as x or y, for example. A number on its own is called a constant. A coefficient is a number used to multiply a variable. An operator is a symbol, such as +, −, ×, etc, that represents an operation between adjacent terms.

As illustrated in FIG. 1B, a term may be either a single number or a variable, or a group of numbers and variables multiplied together. An expression is a group of terms, in which the terms are separated by + or − operators, for example.

Embodiments of the invention may be applied to other disciplines besides algebraic mathematics, such as Boolean logic, trigonometry, calculus, statistics, etc., for example. Thus, while the terms “expression” and “equation” will be used herein to refer to a mathematical or logic representation, embodiments of the invention are not limited to simple algebraic operations and it is understood that these terms are representative of constructs used in other mathematical and logic disciplines.

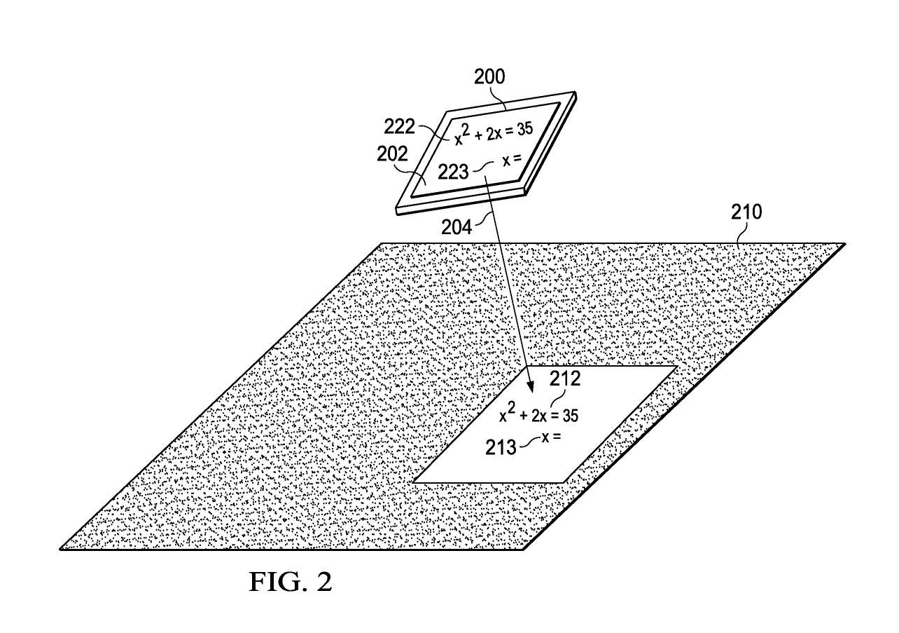

FIG. 2 is an illustration of a smartphone 200 that is being used to observe an equation written on a surface 210, such as a piece of paper or white board, for example. Smartphone 200 includes a graphical display 202 that may be used to display, among other things, information input to applications executing on the smartphone 200 and various outputs of the applications. For example, each application may use one or more windows for displaying input and output information, as is well known in computer technology. The graphical display 202 may be, for example, an LCD display. One or more control buttons (not shown) may be provided in some embodiments, such as a power button, volume control buttons, etc.

Smartphone 200 may not have a dedicated keyboard; instead, one or more applications may provide a virtual, or a “soft keyboard” as is well known. Display 202 may include touch detection circuitry that allows a user to interact with the display 202 by translating the motion and position of the user's fingers on the display 202 to provide functionality similar to using an external pointing device, such as a mouse, and a keyboard. A user may use the touch sensitive display 202 to perform operations similar to using a pointing device on a computer system, e.g., scrolling the display 202 content, pointer positioning, selecting, highlighting, etc.

The general operation of a touch sensitive display screen is well known and need not be described in further detail herein. For example, in some embodiments, a detection circuitry may be located in a peripheral region around the touch sensitive screen. In other embodiments, transparent circuitry may be formed on the face of the screen that detects the presence and location of a finger or pointing instrument that is placed near or in contact with the surface of the screen, etc. Embodiments of the invention may be used with many types of currently known or later development touch sensitive screens.

Referring still to FIG. 2, smartphone 200 includes a camera on the backside of the enclosure that may provide a screen image on display 202 that is obtained from viewing surface 210 along pose line 204. As the smartphone is moved, each resulting pose of the camera may see a different portion of surface 210. In this example, smartphone 200 is posed to view a portion of surface 210 that includes equation 212 and expression 213, which are then displayed on display screen 202 as equation image 222 and expression image 223, for example.

Surface 210 may be any surface that can be viewed by the camera in smartphone 200. Surface 210 may be a white board, a chalk board, a piece of paper on a desk or table, a book or pamphlet, a display screen of another electronic device, etc., for example.

FIG. 3 is an illustration of the display screen 202 of smartphone 200 in more detail. As discussed above, equation image 222 and expression image 223 are being displayed on screen 202 as a result of viewing surface 210. At some point, a user of smartphone 200 may have launched or enabled a math analysis application that may now provide math analysis of the displayed image. Alternatively, the user may view the image and then launch or enable a math analysis application that may provide math analysis of the displayed image. In either case, since the image is an optical pixel image, OCR application software may be executed that converts the optical image to recognize various coefficients, variables, constants, operators, and terms included within equation 222 and expression 223.

There are now many examples of OCR software available for smartphones. For example, Prizmo is a sophisticated OCR app with an easy-to-use interface. Another example is Word Lens, which can be used to translate printed words from one language to another using the smartphone camera in real time. In other examples, an image may be transmitted to a remote processing center and the OCR results returned to the smartphone via the cellular network. These or other OCR apps now known or later developed may be utilized to provide recognized symbol and text data from the optical image on screen 202, for example.

Referring still to FIG. 3, notice that after the = sign 224, no solution is included in the expression image at location 225. Therefore, in this example, a user may be looking for a solution to expression 223. Once computer usable data is available, it is then a simple matter to provide the data to a computational application that can then provide a solution to the expression(s). In some embodiments, a calculation tool provided by the TI-Nspire™ and TI-Nspire™ CAS application programs may be used. In other embodiments, calculation tools provided by other applications, such as Geogebra, MathStudio, PocketCAS, may be used, for example. For more complex computations, tools such as Mathematica may be used, for example. Mathematica is a computational software program used in many scientific, engineering, mathematical, and computing fields, based on symbolic mathematics.

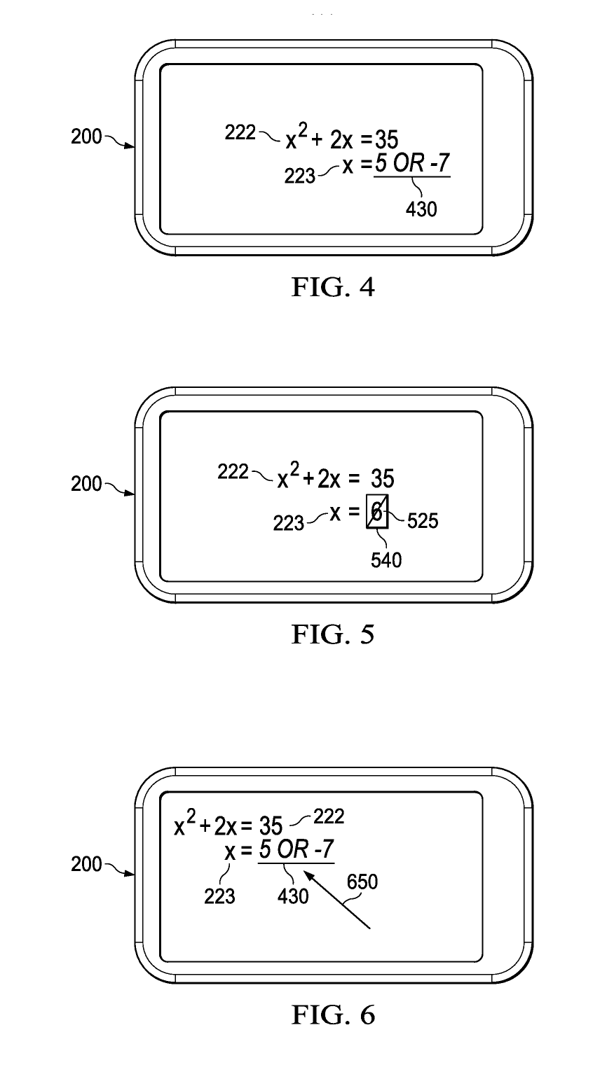

FIG. 4 illustrates how a real time solution 430 to expression 213 may be superimposed over the image of expression 223 on the display screen of smartphone 200. Real time solution 430 of x=5 or −7 is obtained from the onboard computation application, as described above.

FIG. 5 illustrates an alternative situation in which an initial solution 525 of x=6 is included in the initial image for expression 223. In this example, a user may be interested in checking the initial solution for accuracy. This may be useful to a parent for checking a child's homework, for a teacher grading a student's test paper, for an engineer checking a co-worker's work, etc., for example.

In this case, as described above, the correct answer is x=5 or −7, therefore the initial answer 525 is incorrect. In one embodiment, a box 540 with a strike-through or an X, for example, may be superimposed over initial answer 525 as an indication that initial answer 525 is incorrect. Similarly, a plain box may be superimposed over an initial correct answer to indicate the initial answer is correct. In other embodiments, various types of overlays may be used to indicate the initial answer is either incorrect or correct, such as different colors (red for wrong, green for correct, for example), shadings, strike-through, underlines, blinking area, etc., for example.

FIG. 6 illustrates movement 650 of the screen image that may be the result of moving smartphone 200 and thereby changing the view of the camera. In this case, motion detection software may be executed that monitors various features within the image. As motion of the features is detected, the superimposed indication 430 of the solution may also be moved so that it remains positioned properly with respect to expression 223.

In another embodiment, the motion may be due to the fact that the image being displayed is a video that was previously recorded by the smartphone or that was obtained from another source via the cellular network or a plug in memory chip, for example.

In another embodiment, the image of expression 222, 223 may be “captured” to produce a still image. For example, the user may tap a physical or virtual button to cause a picture to be snapped by the camera. The still picture may then be OCR'd and the resulting data may be processed for math solutions as described above. In this case, the indication of the real-time solution may then be superimposed onto the still image, as described above.

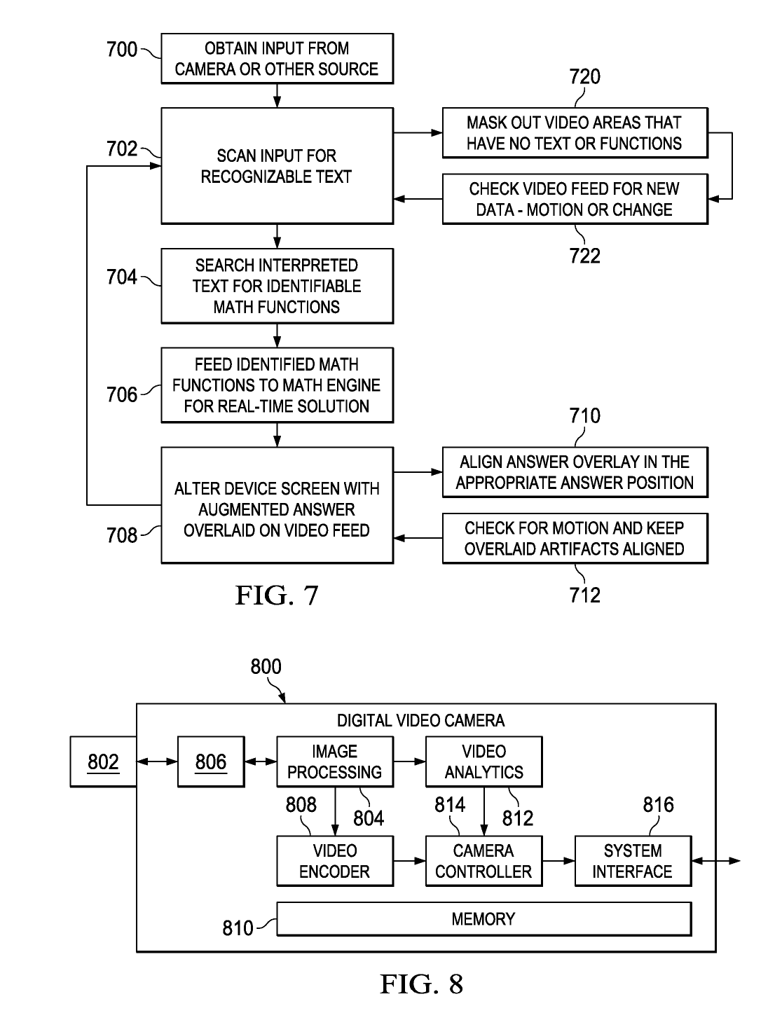

FIG. 7 is a flow chart illustrating a method for evaluating equations by observing an image of the equations. A device that embodies this method may obtain a document 700 from a camera that is part of the device or from other sources, such as on-line sources via various networks, such as local area networks, wide area networks, the World Wide Web, cellular networks, etc., for example. While the term “document” is used here, the term is not intended to be limited to any particular type of document. A document may be a live video feed from a camera, a still picture snapped by a camera, or various types of image files such as pdf, mpeg, jpeg, faxes, scanned images, etc., for example.

As an image of the document is displayed on a display screen of the device, the document is scanned 702 for recognizable text using OCR software, as described in more detail above. Typically, the OCR process will mask out 720 portions of the image that have no text or math type functions.

If the document is a video, such as live video from the camera or a video file, then the OCR process may repeat 722 as new frames are provided. Depending on the embodiment, this may happen automatically in a periodic manner, such as after a certain number of video frames, or after a certain time period, for example. In another embodiment, the OCR process may be responsive to a user input, such as tapping on a touch sensitive screen to cause an OCR update, for example. In another embodiment, the OCR process may be triggered by detecting that the camera has “paused” or is “hovering” over a scene, for example. In this case, a user may be holding the camera over a student paper, for example.

When an OCR operation on a screen frame is completed, a software program may then analyze the data 704 to determine if one or more expressions or equations are present. This may be done by looking for various operators such as +, −, ×, /, etc., for example. The location of equality or inequality symbols, such as =, ≈, ≠, ≡, ≦, ≧, etc., for example, may be used to determine where a solution should be placed.

Once an equation or expression is identified, it may then be fed 706 to a math computation software application to determine a real-time solution for the equation, as described in more detail above.

An indication of the real-time solution may then be superimposed 708 on the screen image. As discussed above, the indication may be the solution to the equation, or it may be an indication that an initial solution included with the image of the equation is correct or incorrect.

Based on the equality or inequality symbol for an expression, the solution indication may be aligned 710 in an appropriate location for the solution. Some embodiments may also check for motion 712 of the screen image and move the solution overlay accordingly to maintain its appropriate location with respect to the equation image.

### Camera

FIG. 8 is a block diagram of a digital camera 800 contained within the smartphone 200 of FIGS. 2-6. Camera 800 may include an imaging component 802, a controller component 806, an image processing component 804, a video encoder component 818, a memory component 810, a video analytics component 812, a camera controller 814, and a network interface 816. The components of the camera 800 may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc. Further, software instructions such as software instructions embodying at least part of the pose estimation may be stored in memory in the memory component 810 and executed by one or more processors.

The imaging component 802 and the controller component 806 include functionality for capturing images of a scene. The imaging component 802 may include a lens assembly, a lens actuator, an aperture, and an imaging sensor. The imaging component 802 may also include circuitry for controlling various aspects of the operation of the component, such as, for example, aperture opening amount, exposure time, etc. The controller module 806 includes functionality to convey control information from the camera controller 814 to the imaging component 802, and to provide digital image signals to the image processing component 804.

The image processing component 804 divides the incoming digital signals into frames of pixels and may process each frame to enhance the image data in the frame. The processing performed may include one or more image enhancement techniques, such as, for example, one or more of black clamping, fault pixel correction, color filter array (CFA) interpolation, gamma correction, white balancing, color space conversion, edge enhancement, denoising, contrast enhancement, detection of the quality of the lens focus for auto focusing, and detection of average scene brightness for auto exposure adjustment. Digital images from the image processing component 804 are provided to the video encoder component 808, and the motion estimation/video analytics component 812.

The video encoder component 808 may encode the images in accordance with a video compression standard such as, for example, the Moving Picture Experts Group (MPEG) video compression standards, e.g., MPEG-1, MPEG-2, and MPEG-4, the ITU-T video compressions standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), the ITU-T/ISO High Efficiency Video Coding (HEVC) standard, etc.

The memory component 810 may be on-chip memory, external memory, or a combination thereof. Any suitable memory design may be used. For example, the memory component 810 may include static random access memory (SRAM), dynamic random access memory (DRAM), synchronous DRAM (SDRAM), read-only memory (ROM), flash memory, a combination thereof, or the like. Various components in the digital video camera 800 may store information in memory in the memory component 810 as a video stream is processed. For example, the video encoder component 808 may store reference data in a memory of the memory component 810 for use in encoding frames in the video stream. Further, the memory component 810 may store any software instructions that are executed by one or more processors (not shown) to perform some or all of the described functionality of the various components.

Some or all of the software instructions may be initially stored in a computer-readable medium such as a compact disc (CD), a diskette, a tape, a file, memory, or any other computer readable storage device and loaded and stored on the digital video camera 300. In some cases, the software instructions may also be sold in a computer program product, which includes the computer-readable medium and packaging materials for the computer-readable medium. In some cases, the software instructions may be distributed to the digital video camera 800 via removable computer readable media (e.g., floppy disk, optical disk, flash memory, USB key), via a transmission path from computer readable media on another computer system (e.g., a server), etc.

The camera controller component 814 may control the overall functioning of the digital video camera 800. For example, the camera controller component 814 may adjust the focus and/or exposure of the imaging component 802 based on the focus quality and scene brightness, respectively, determined by the image processing component 804. The camera controller component 814 also controls the transmission of the encoded video stream via the network interface component 816 and may control reception and response to camera control information received via the network interface component 816. Further, the camera controller component 814 controls the transfer information from the video analytics component 812 via the system interface component 816.

The interface component 816 allows the digital video camera 800 to communicate with a monitoring system located within the mobile device.

The video analytics component 812 analyzes the content of images in the captured video stream to detect and determine temporal events not based on a single image. The analysis capabilities of the video analytics component 812 may vary in embodiments depending on such factors as the processing capability of the digital video camera 800, the particular application for which the digital video camera is being used, etc. For example, the analysis capabilities may range from video motion detection in which motion is detected with respect to a fixed background model to face recognition, object recognition, gesture recognition, feature detection and tracking, etc.

Motion detection technology is well known and need not be described in more detail herein. Typically, an image may be divided into a number of boxes or zones, and features such as edges, corners, etc, may be tracked from box to box by comparison of pixels, for example.

### Smartphone Example

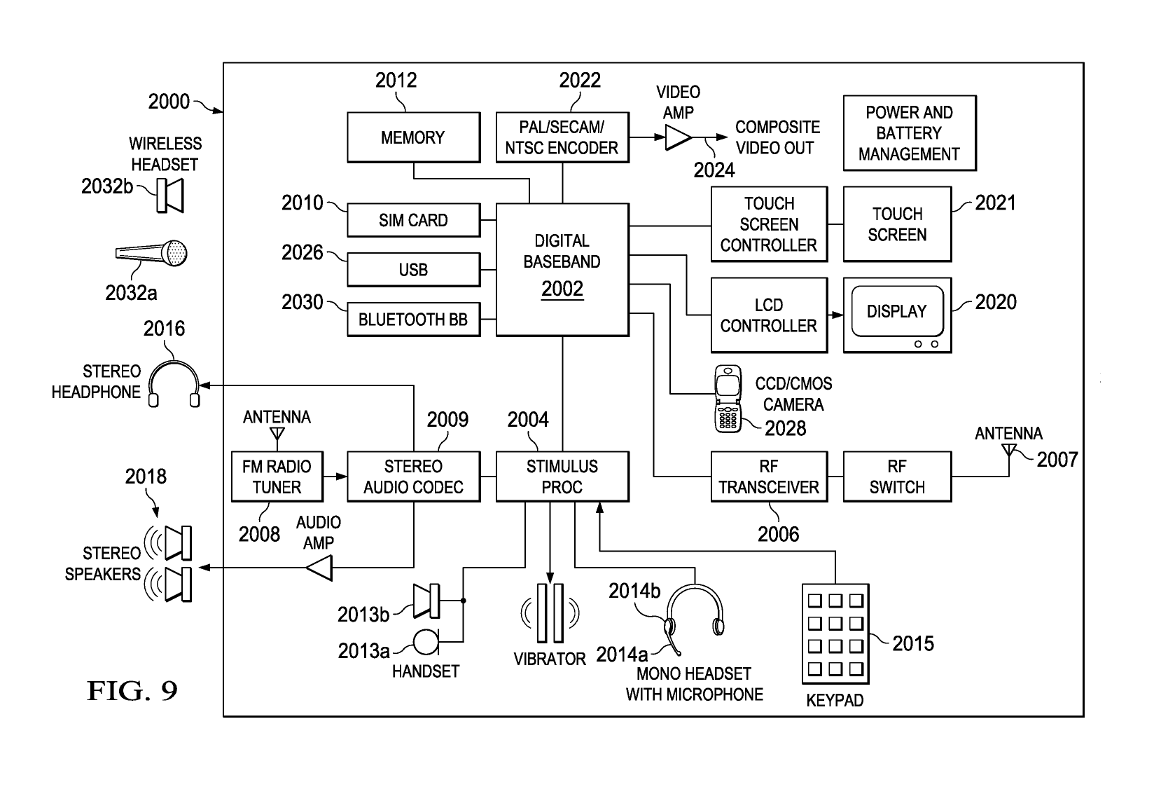

FIG. 9 is a block diagram of an exemplary mobile cellular smartphone 2000 that includes an embodiment of the present invention. Digital baseband (DBB) unit 2002 may include a digital processing processor system (DSP) that includes embedded memory and security features. Stimulus Processing (SP) unit 2004 receives a voice data stream from handset microphone 2013a and sends a voice data stream to handset mono speaker 2013b. SP unit 2004 also receives a voice data stream from microphone 2014a and sends a voice data stream to mono headset 2014b. Usually, SP and DBB are separate ICs. In most embodiments, SP does not embed a programmable processor core, but performs processing based on configuration of audio paths, filters, gains, etc being setup by software running on the DBB. In an alternate embodiment, SP processing is performed on the same processor that performs DBB processing. In another embodiment, a separate DSP or other type of processor performs SP processing.

RF transceiver 2006 is a digital radio processor and includes a receiver for receiving a stream of coded data frames from a cellular base station via antenna 2007 and a transmitter for transmitting a stream of coded data frames to the cellular base station via antenna 2007. RF transceiver 2006 is coupled to DBB 2002 which provides processing of the frames of encoded data being received and transmitted by cell phone 2000.

DBB unit 2002 may send or receive data to various devices connected to universal serial bus (USB) port 2026. DBB 2002 can be connected to subscriber identity module (SIM) card 2010 and stores and retrieves information used for making calls via the cellular system. DBB 2002 can also be connected to memory 2012 that augments the onboard memory and is used for various processing needs. DBB 2002 can be connected to Bluetooth baseband unit 2030 for wireless connection to a microphone 2032a and headset 2032b for sending and receiving voice data. DBB 2002 may also be connected to display 2020 and can send information to it for interaction with a user of the mobile UE 2000 during a call process. Touch screen 2021 may be connected to DBB 2002 for haptic feedback. Display 2020 may also display pictures received from the network, from a local camera 2028, or from other sources such as USB 2026. DBB 2002 may also send a video stream to display 2020 that is received from various sources such as the cellular network via RF transceiver 2006 or camera 2028. DBB 2002 may also send a video stream to an external video display unit via encoder 2022 over composite output terminal 2024. Encoder unit 2022 can provide encoding according to PAL/SECAM/NTSC video standards. In some embodiments, audio codec 2009 receives an audio stream from FM Radio tuner 2008 and sends an audio stream to stereo headset 2016 and/or stereo speakers 2018. In other embodiments, there may be other sources of an audio stream, such a compact disc (CD) player, a solid state memory module, etc.

Camera 2028 may be implemented as described in more detail above with respect to FIG. 8, for example. Image data may be received from various sources, such as: memory 2012, simcard 2010, memory within camera 2028, for example. Image data may be downloaded on a data channel from a cellular network, for example.

An application may be loaded in memory 2012 and executed by processor 2002 in company with processing logic in camera 2028 to acquire and display a screen image of a document, identify an image of an equation within a portion of the screen image by parsing the document using a processor 2002 or a remote processor accessed via the cellular network; calculate a real-time solution to the equation; and provide an indication of the real-time solution to the equation on the display screen, as described in more detail above.

### Other Embodiments

While the invention has been described with respect to a limited number of embodiments, those skilled in the art, having benefit of this disclosure, will appreciate that other embodiments can be devised which do not depart from the scope of the invention as disclosed herein. For example, embodiments are described herein in which algebraic equations are evaluated. Other embodiments may evaluate various types of equations, such as: linear and polynomial equations, transcendental equations, parametric equations, functional equations, differential equations, integral equations, trigonometry functions, statistics functions, etc., for example.

In some embodiments, a single processor may be used to execute instructions to perform camera image capture, motion detection, OCR and math computation functions. In other embodiments, two or more processors may cooperate to perform the various tasks.

While embodiments of a smartphone were described herein, other embodiments may include various portable and hand-held devices, such as tablets, personal digital assistants, and other mobile digital devices. Various embodiments may include devices such as: head-mounted devices, wrist mounted devices, vehicle mounted devices, wall mounted devices, drone mounted devices, etc., for example.

Embodiments of a math evaluation tool were described herein in conjunction with a calculation tool provided by the TI-Nspire™ and TI-Nspire™ CAS application programs. In other embodiments, a math evaluation tool as described herein may be used in conjunction with calculation tools provided by other applications, such as Geogebra, MathStudio, PocketCAS, for example.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope of the invention.

What is claimed is:

1. A method for evaluating equations, the method comprising:
displaying a screen image of a document on a display screen of a device;
identifying an image of an equation within a portion of the screen image by parsing the document using a processor coupled to the display screen;
calculating a real-time solution to the equation; and
providing an indication of the real-time solution to the equation on the display screen.

2. The method of claim 1, wherein providing an indication of the solution comprises superimposing an image of the real-time solution to the equation over the image of the equation on the display screen of the device.

3. The method of claim 1, further comprising:
determining that the image of the equation includes an initial solution;
comparing the initial solution to the real-time solution; and
wherein providing an indication of the solution comprises superimposing an indication of correctness of the initial solution over the image of the equation on the screen of the camera.

4. The method of claim 1, wherein identifying an image of an equation comprises interpreting the terms of the equation by performing optical character recognition of the image of the equation.

5. The method of claim 1, further comprising viewing a surface with a camera coupled to the display screen, wherein the document is a real-time image viewed by the camera.

6. The method of claim 5, further comprising capturing the real-time image of the equation on the display screen; and
wherein the indication of the real-time solution is superimposed on the captured image of the equation on the display screen.

7. The method of claim 1, wherein the equation includes multiple unknown variables and wherein producing a real-time solution comprises solving for the multiple unknown variables.

8. The method of claim 1, wherein the equation is a Boolean equation.

9. The method of claim 1, further comprising detecting a user input and wherein producing the real-time solution is performed in response to the user input.

10. The method of claim 1, wherein the image of the equation on the display screen is a dynamic image, further comprising detecting motion of the image of the equation; and
wherein the indication of the real-time solution is properly superimposed on the dynamic image of the equation on the display screen as the image of the equation moves.

11. A mobile device comprising:
processing logic encased in a housing;
a display screen on a surface of the housing coupled to the processing logic;
a camera mounted to the housing;
wherein the processor logic is configured to perform a method for solving math equations, the method comprising:
forming an image of an equation on the display screen by viewing the equation with the camera;
interpreting the terms of the equation by performing optical character recognition of the image of the equation;
producing a real-time solution to the equation; and
providing an indication of the real-time solution to the equation on the display screen.

12. The mobile device of claim 11, wherein providing an indication of the real-time solution comprises superimposing the real-time solution to the equation over the image of the equation on the display screen of the camera.

13. The mobile device of claim 11, further comprising:
determining that the image of the equation includes an initial solution;
comparing the initial solution to the real-time solution; and
wherein providing an indication of the solution comprises superimposing an indication of correctness of the initial solution over the image of the equation on the screen of the camera.

14. The mobile device of claim 11, wherein the equation includes multiple unknown variables and wherein producing a real-time solution comprises solving for the multiple unknown variables.

15. The mobile device of claim 11, wherein the equation is a Boolean equation.

16. The mobile device of claim 11, further comprising detecting a user input and wherein producing the real-time solution is performed in response to the user input.

17. The mobile device of claim 11, further comprising capturing the image of the equation on the display screen; and
wherein the indication of the real-time solution is superimposed on the captured image of the equation on the display screen.

18. The mobile device of claim 11, wherein the image of the equation on the display screen is a dynamic image, further comprising detecting motion of the image of the equation; and
wherein the indication of the real-time solution is properly superimposed on the dynamic image of the equation on the display screen as the image of the equation moves.

19. A non-transitory computer readable medium storing software instructions that, when executed by at least one processor in a device, perform a method of
displaying a screen image of a document on a display screen of the device;
identifying an image of an equation within a portion of the screen image by parsing the document using a processor coupled to the display screen;
calculating a real-time solution to the equation; and
providing an indication of the real-time solution to the equation on the display screen.

20. The method of claim 19, wherein providing an indication of the solution comprises:
determining that the image of the equation does not include an initial solution; and superimposing an image of the real-time solution to the equation over the image of the equation on the display screen of the device; or
determining that the image of the equation does includes an initial solution; comparing the initial solution to the real-time solution; and superimposing an indication of correctness of the initial solution over the image of the equation on the screen of the device.
